(19) United States
(12) Patent Application Publication
(10) Pub. No.: US 2009/0054054 A1
(43) Pub. Date: Feb. 26, 2009

(54) SYSTEM AND METHOD FOR MAINTAINING RELIABLE BEACON TRANSMISSION AND RECEPTION IN A WIRELESS COMMUNICATION NETWORK

(75) Inventors: Huai-Rong Shao, Santa Clara, CA (US); Harkirat Singh, Santa Clara, CA (US); Xiangping Qin, San Jose, CA (US); Chiu Ngo, San Francisco, CA (US)

Correspondence Address: KNOBBE, MARTENS, OLSON, & BEAR, LLP, 2040 MAIN STREET, FOURTEENTH FLOOR, IRVINE, CA, 92614, US

(73) Assignee: Samsung Electronics Co., Ltd., Suwon City (KR)

(21) Appl. No.: 12/189,714

(22) Filed: Aug. 11, 2008

Related U.S. Application Data
(60) Provisional application No. 60/965,557, filed on Aug. 20, 2007.

(51) Int. Cl. H04B 7/24

(52) U.S. Cl. 455/422.1; 455/39

(57) ABSTRACT

Systems and methods for maintaining reliable beacon transmission and reception in a wireless communication network are disclosed herein. In one embodiment, there is a method of communicating in a wireless communication network comprising a first device and a second device, the method comprising selecting, by the first device, a wireless communication direction for communication of data, wherein the wireless communication direction comprises at least one of a reception direction of the first device, a reception direction of the second device, a transmission direction of the first device, or a transmission direction of the second device, associating, by the first device, with the second device in the selected wireless communication direction, receiving, by the first device, a plurality of signals transmitted in different directions by the second device, the plurality of signals comprising a first signal in the selected wireless communication direction and a second signal transmitted in another direction different from the selected wireless communication direction, and determining, by the first device, one or more measures of quality of the first and second signals.

### CROSS-REFERENCE TO RELATED APPLICATIONS

This application claims the benefit under 35 U.S.C. 119(e) of U.S. Provisional Application No. 60/965,557, filed on Aug. 20, 2007, which is incorporated by reference in its entirety.

### BACKGROUND

1. Field

The present application relates to wireless networks, and in particular, to beacon transmission and reception for a wireless communication network.

2. Description of the Related Technology

A wireless communication network is commonly associated with a telecommunications network where the interconnections among the communication devices is implemented without the use of wires. Wireless telecommunications networks are generally implemented with some type of remote information transmission system that uses electromagnetic waves, such as radio waves, for the carrier and this implementation usually takes place at the layer of the network.

A wireless personal area network (WPAN) is one type of wireless network used for communication among a plurality of devices, such as computers, mobile phones, personal digital assistants, printers, digital cameras, televisions, media players, etc. Usually, a WPAN covers a short range up to 10 or 20 meters. A number of standards for network communications have recently been developed, including, but not limited to, Bluetooth and IEEE 802.15.

### SUMMARY OF CERTAIN INVENTIVE ASPECTS

One aspect of the invention is a method of communicating in a wireless communication network comprising a first device and a second device, the method comprising selecting, by the first device, a wireless communication direction for communication of data, wherein the wireless communication direction comprises at least one of a reception direction of the first device, a reception direction of the second device, a transmission direction of the first device, or a transmission direction of the second device, associating, by the first device, with the second device in the selected wireless communication direction, receiving, by the first device, a plurality of signals transmitted in different directions by the second device, the plurality of signals comprising a first signal in the selected wireless communication direction and a second signal transmitted in another direction different from the selected wireless communication direction, and determining, by the first device, one or more measures of quality of the first and second signals.

Another aspect of the invention is a wireless communication device, comprising a selection module configured to select a wireless communication direction for communication of data, wherein the wireless communication direction comprises at least one of a reception direction of the first device, a reception direction of the second device, a transmission direction of the first device, or a transmission direction of the second device, an association module configured to associate with the second device in the selected wireless communication direction, a receiver configured to receive a plurality of signals transmitted in different directions by the second device, the plurality of signals comprising a first signal in the selected wireless communication direction and a second signal transmitted in another direction different from the selected wireless communication direction, and a measurement module configured to determine one or more measures of quality of the first and second signals.

Another aspect of the invention is a method of communication in a wireless communication network comprising a first device and a second device, the method comprising receiving, by the second device, an association request message from the first device specifying a selected transmission direction of the second device, transmitting, by the second device, a plurality of signals in different transmission directions after receiving the association request message, receiving, by the second device from the first device, a request to select a second transmission direction after transmitting the plurality of signals, and changing, by the second device, the selected transmission direction upon receiving the request to select the second transmission direction.

Yet another aspect of the invention is a device for wireless communication, comprising a receiver configured to receive an association request message from a first device specifying a selected first transmission direction of the device, a transmitter configured to transmit a plurality of signals in different transmission directions after the association message is received by the receiver, wherein the receiver is further configured to receive a request from the first device to select a second transmission direction after the plurality of signals is transmitted by the transmitter, and a changing module configured to change the selected transmission direction upon receiving the request to select the second transmission direction.

### BRIEF DESCRIPTION OF THE DRAWINGS

FIG. 1 is a diagram of a wireless network between wireless devices having a variety of directional and omni-directional antennae.

FIG. 2 is a functional block diagram of an example communication system for transmission of data over a wireless medium, according to one embodiment.

FIG. 3 is a diagram of a time partitioned into a plurality of superframes, according to one embodiment.

FIG. 4 is a flowchart illustrating a method of maintaining a robust connection using direction switching.

FIG. 5A shows an exemplary wireless network including a coordinator and an omni-directional device.

FIG. 5B shows the exemplary network of FIG. 5A after the device has been moved.

FIG. 6A shows another exemplary wireless network including a coordinator and a directional device.

FIG. 6B shows the exemplary network of FIG. 6A after the device has been moved.

FIG. 7 is a diagram of a superframe in which a CTA is reserved for the transmission of a number of beacons transmitted in different coordinator transmission directions.

### DETAILED DESCRIPTION OF CERTAIN INVENTIVE EMBODIMENTS

Certain embodiments provide a method and system for ensuring reliable beacon transmission in wireless networks. The following detailed description is directed to certain sample embodiments of the invention. However, the invention can be embodied in a multitude of different ways as defined and covered by the claims. In this description, reference is made to the drawings wherein like parts are designated with like numerals throughout.

### WPAN System Overview

A wireless personal area network (WPAN) system is a computer network used in communication between devices (for example, telephones and personal digital assistants) close to a single person. The devices may or may not belong to the person in question. The reach of a WPAN is typically a few meters, but may be more under certain circumstances. A WPAN may be used to communicate between the devices, or to interconnect with a higher level network such as the internet. A number of standards for network communications have recently been developed, including, but not limited to, Bluetooth and IEEE 802.15.

As a WPAN involves wireless communication, movement of the devices within the network is not hindered by the connection of wires; however, movement of the devices or changes in the environment may disrupt communications between devices by changing the characteristics of the channel between them. There is a need for a method of maintaining reliable transmission and reception in a wireless network, such as a WPAN.

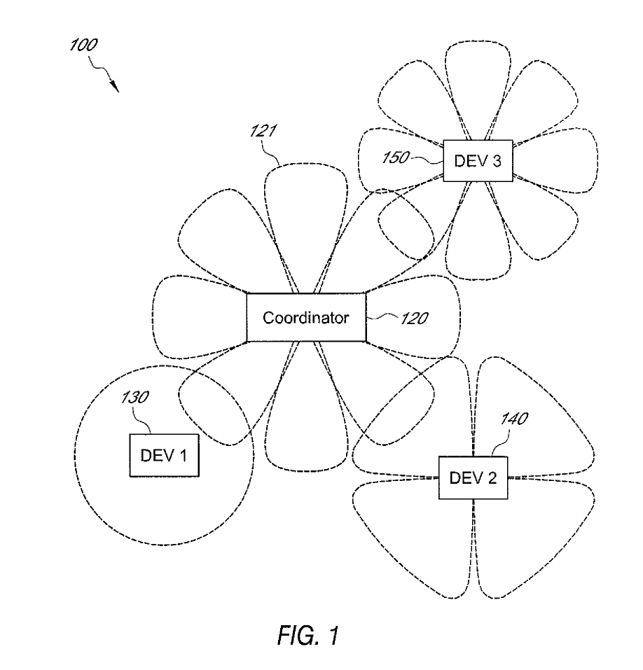

FIG. 1 is a diagram of an exemplary wireless personal area network according to one embodiment. The illustrated network 100 includes a coordinator 120 and first to third devices 130, 140, 150. The coordinator 120 and the first to third devices 130, 140, 150 may communicate using a variety of different parameters, including different modulation and coding schemes, different protocols, different random access schemes, and different frequency bands.

The coordinator 120 may be responsible for coordinating data transfer between itself and other devices. The coordinator 120 may partition a wireless channel into a number of time periods and schedule communication between specific devices during those time periods. The coordinator may be, for example, a television, a set-top box, a personal computer, a laptop computer, or a dedicated controlling box.

In the network 100 of FIG. 1, the coordinator 120 is configured to perform directional transmission and/or reception with the first to third devices 130, 140, 150. The coordinator 120 may utilize sector antennas for the directional transmission and/or reception. Each sector 121 represents a different direction for transmission or reception of data. The coordinator 120 selects a sector and, while the sector is selected, is able to transmit or receive data in that direction.

The first device 130 may utilize omni-directional transmission and reception. The second device 140 may utilize a sectored antenna with more or less sectors than the coordinator 120. In addition, the third device 150 may utilize a sector antenna with the same number of sectors as the coordinator 120. Each of the first to third devices 130, 140, 150 can be a television, a desktop computer, a laptop computer, a set-top box, a DVD player or recorder, a VTR, an audio player, a digital camera, a camcorder, a game device, or a computer peripheral such as a mouse, a keyboard, a printer, or a scanner.

In directional transmission, beamforming may also be used by either the coordinator 320 or one or more of the devices. In some embodiments, an asymmetric antenna system (AAS) may be employed by either the coordinator or one or more of the devices, resulting in different sets of transmission and reception directions.

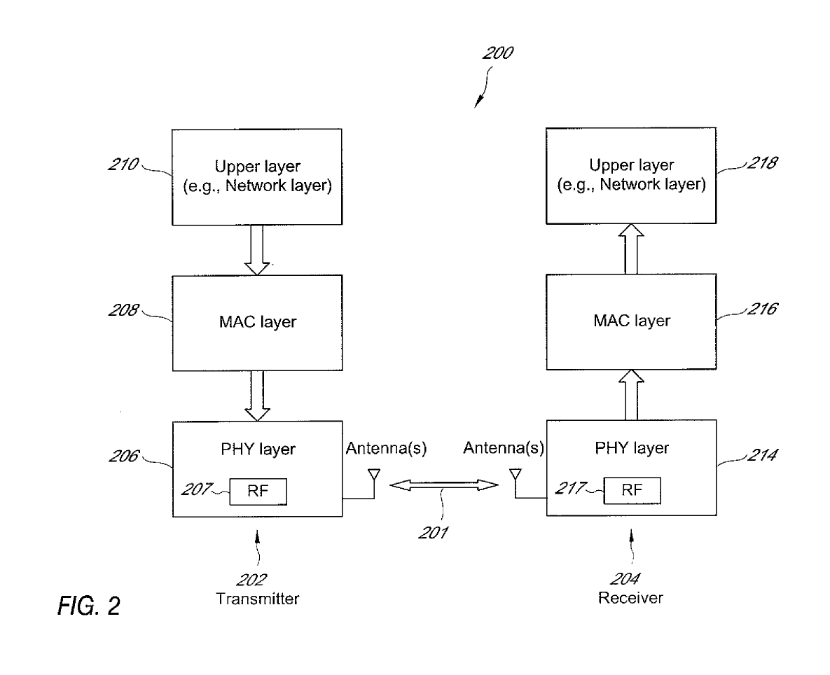

FIG. 2 shows a generalized block diagram illustrating an example wireless personal area network (WPAN) system 200. The example WPAN system 200 includes a wireless transmitter 202 and wireless receiver 204. The transmitter 202 includes a physical (PHY) layer 206, a media access control (MAC) layer 208, an upper layer 210, and one or more antennas. Similarly, the receiver 204 includes a PHY layer 214, a MAC layer 216, an upper layer 218, and one or more antennas. In some embodiments, the PHY layers 206, 214 include radio frequency (RF) modules 207, 217. The PHY layers 206, 214 provide wireless communication between the transmitter 202 and the receiver 204 via the RF modules 207, 217 and the one or more antennas through a wireless medium 201.

The upper layers 210, 218 represent one or more layers that are above the MAC layers 208, 216, respectively, and send command and/or data messages to the MAC layers. In certain embodiments (e.g., OSI or TCP/IP models), the upper layer 210, 218 includes a network layer. In certain embodiments, the network layer includes an IP protocol that performs the basic task of getting data packets from source to destination. In other embodiments (e.g., five-layer TCP/IP model), the upper layer 210, 218 further includes a transport layer and an application layer. In other embodiments, (e.g., seven-layer OSI model), the upper layer 210, 218, in addition to the transport layer and the application layer, further includes a session layer and a presentation layer.

In the wireless transmitter 202, the upper layer 210 provides data (e.g., text, graphics, or audio data) and/or command messages to the MAC layer 208. In certain embodiments, the MAC layer 208 can include a packetization module (not shown) which puts the data and/or command messages into the form of one or more data packets. The MAC layer 208 then passes the data packets to the PHY layer 206. The PHY/MAC layers of the transmitter 202 add PHY and MAC headers to the data packets. The PHY layer 206 transmits wireless signals including the data packets to the receiver 204 via the RF module 207 over the wireless channel 201.

In the wireless receiver 204, the PHY layer 214 receives the transmitted wireless signals including the data packets via the RF module 217. The PHY/MAC layers 214, 216 then process the received data packets to extract one or more data/command messages. The extracted data/command messages are passed to the upper layer 210 where the messages are further processed and/or transferred to other modules or devices to be displayed (text or graphics) or played (audio), for example.

### Wireless Network Employing Beacon Signals

In the illustrated wireless network of FIG. 1, the coordinator 120 may send beacons at a time interval for scheduling transmissions between the wireless devices. Beacons may carry network control/management information such as channel time scheduling. In one arrangement, beacons may be transmitted omni-directionally. In other arrangements, beacons may be transmitted directionally with, for example, a sectored antenna which has a specific coverage angle for a single transmission. In one embodiment, the coverage angle may be about 5 degrees, 10 degrees, 45 degrees, or 90 degrees. A skilled technologist will appreciate that the coverage angle may vary widely depending on the design of the sectored antenna.

In the arrangements where beacons are transmitted directionally, an omni-directional beacon may be emulated by transmitting directional beacons sequentially to substantially all directions. In transmitting directional beacons, a relatively robust modulation and coding scheme (MCS) may be used to support reliable beacon transmission.

However, a robust modulation and coding scheme may not be enough to ensure reliable transmission, as there are other issues that affect the beacon reliability that are not present in the omni-directional case. For example, if a device is located at the boundary of two directional sectors of another device, such as the coordinator, the beacon signal that the device receives may be weak. For another example, directional beacon transmission may be easily blocked by a physical obstruction if a 60 GHz wireless channel is used. For yet another example, if a device is moving while receiving beacons in one sector, the device may fail to receive beacons if it is moved from the sector from which the beacon is transmitted.

Some embodiments provide reliable beacon transmission mechanisms when directional antennas are used. In one embodiment, directional beacon monitoring and switching mechanisms are provided to maintain reliable beacon transmission. In other embodiments, methods and systems provide multiple copies of the same beacon information in beacons transmitted at different directions to further improve beacon reliability.

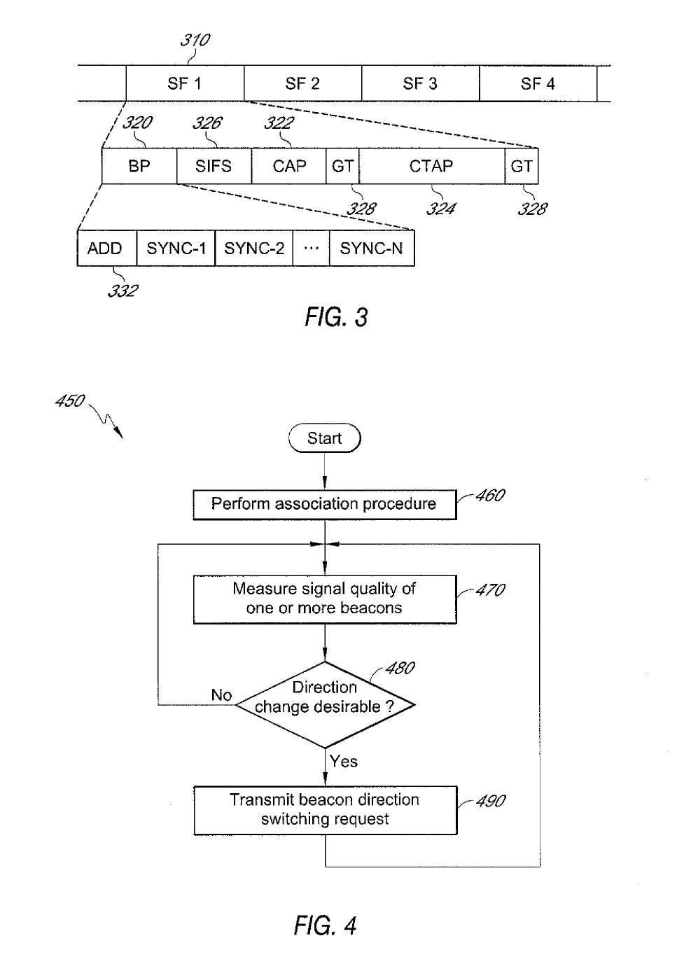

The network 100 described above in connection with FIG. 1 may operate by transmitting and receiving information by partitioning time into a multitude of superframe time periods. FIG. 3 is a diagram of time partitioned into a plurality of superframes, according to one embodiment. During a particular superframe 310, time may be further partitioned into a beacon period 320, a contention access period (CAP) 322, and a channel time allocation period (CTAP) 324. A superframe may also include other time partitions between two of the foregoing periods 320, 322, 324, such as guard time periods where nothing is expected to be transmitted. A skilled technologist will appreciate that the superframe may have any other suitable periods, depending on the design of the network.

During the beacon period 320, the coordinator, such as coordinator 120 of FIG. 1, transmits beacons. A beacon may, for example, contain information about the network, such as information about the coordinator 120, the network 100, or superframe partitioning. A beacon may also contain reservation schedule information for devices in the network. Beacons may be transmitted omni-directionally or in a particular direction. Beacons may be transmitted using any of a number of modulation and coding schemes, including orthogonal frequency division multiplexing (OFDM) and single-carrier transmission. Beacons may be broadcast, such that any device may receive and interpret the beacon, or they may be addressed to a particular device. Beacons transmitted within the beacon period 320 are not necessarily the same size, and thus do not necessarily take the same amount of time to transmit. The beacon period 320 may be partitioned into sub-beacon periods, where one beacon is transmitted by the coordinator during each sub-beacon period.

In some embodiments, a single beacon sent during a sub-beacon period may be addressed to more than one device. For example, if two devices are within the same sector of the coordinator, the coordinator may transmit a beacon containing information for both of the devices. If the coordinator were to send two beacons, one for each device, it may be redundantly sending the same information, such as a preamble or MAC header, in the same direction. By combining the two beacons into one, the coordinator reduces this redundancy.

The beacons transmitted may include an automatic device discover (ADD) beacon 332. In one embodiment, one ADD beacon is transmitted in a different direction each superframe, thus a number of superframes must pass before an ADD beacon has been transmitted in each direction. In other embodiments, an ADD beacon is transmitted in more than one direction during a single superframe. If a device receives an ADD beacon from a particular direction, the device will try to associate with the coordinator during the contention-based access period 322. After successful association, the coordinator 120 will transmit, and the device will receive synchronization (SYNC) beacons regularly in that particular direction during the beacon period 320. A synchronization beacon may be transmitted in a particular direction to a particular device located in that direction and may contain reservation schedule information for that device. Reservation schedule information may include information about when the coordinator and the device may exchange data during the controlled time access period 324.

### Generalized Direction Switching

FIG. 4 is a flowchart illustrating a method of maintaining a robust connection using direction switching. The process 450 begins, in block 460, by performing an association procedure in order to establish a channel for communication between a coordinator and a device. In one embodiment, this is performed by receiving an automatic device discovery (ADD) beacon. An ADD beacon may be transmitted by the coordinator to establish a connection with other devices. Upon receiving the ADD beacon, an association request is transmitted by the device. In some embodiments, the association request is transmitted by a device after the device has received a number of ADD beacons transmitted by the coordinator in a number of different transmission direction, and received by the device in a number of different reception directions. A transmission direction refers to a region of space in which the strength of a transmitted signal received in the region of space is stronger than the strength of the transmitted signal received outside the region of space. A reception direction similarly refers to a region of space in which the received strength of signals transmitted from within the region is stronger than the received strength of signals transmitted from outside the region. By measuring the signal quality of a number of beacons transmitted and received in different directions, the device can select a preferred transmission direction, reception direction, or both.

In some embodiments, the device transmits the association request during a superframe in which the coordinator transmits an ADD beacon in a selected coordinator transmission direction, in order to indicate that further communication between the coordinator and the device should occur using that selected direction. Reservation schedule information may be included in a SYNC beacon transmitted by the coordinator to the device in the selected direction.

In block 370, the signal quality of one or more beacons is measured. One such measure of signal quality is signal-to-noise ratio (SNR). Other measures of signal quality may be used, such as bit error rate, or measures of signal stability. In some embodiments, this one or more beacons measured include the synchronization (SYNC) beacon received by a device. In addition, the signal quality of other beacons, such as ADD beacons, SYNC beacons to other devices, or direction measurement signals may be measured. One or more ADD beacons are typically transmitted independently by the coordinator in each superframe. One or more SYNC beacons to other devices may be transmitted in each superframe. Direction measurement signals may be transmitted in response to the device requesting transmission of direction measurement signals, other devices requesting transmission of direction measurement signals, or as determined by the coordinator. For example, the coordinator may independently determine that directional measurement signals should be transmitted due to traffic conditions or signal quality measured by the coordinator. Alternatively, the coordinator may transmit directional measurement signals according to pre-defined rules or standards which may require that a directional measurement period by included in every tenth or hundredth superframe.

In block 480, it is determined whether or not a change in the communications direction is desirable. For example, a change in communications direction may be determined to be desirable upon first indication that a different coordinator transmission direction or direction pair would yield higher signal quality. In other embodiments, a change in direction is determined to be desirable only when it is continuously detected that a different coordinator transmission direction or direction pair provides a higher signal quality than the selected direction. This may be indicated when a certain number, e.g., three, measurements of signal quality for a particular coordinator transmission direction or direction pair are higher than the measurements of signal quality for the selected direction pair performed during the same superframe.

In response to a determination that a direction change is desirable, a beacon direction switching request is transmitted, in block 490. The beacon direction switching request may include information about a newly selected coordinator transmission direction in which the coordinator should transmit further communications, or a newly selected direction pair including a coordinator transmission direction in which the coordinator should transmit further communications. Following this stage, or if it is determined that a direction change is not desirable, the process 450 returns to block 470 to continue to receive SYNC beacons and perform the rest of the process.

### Beacon Quality Maintenance for an Omni-Directional Device

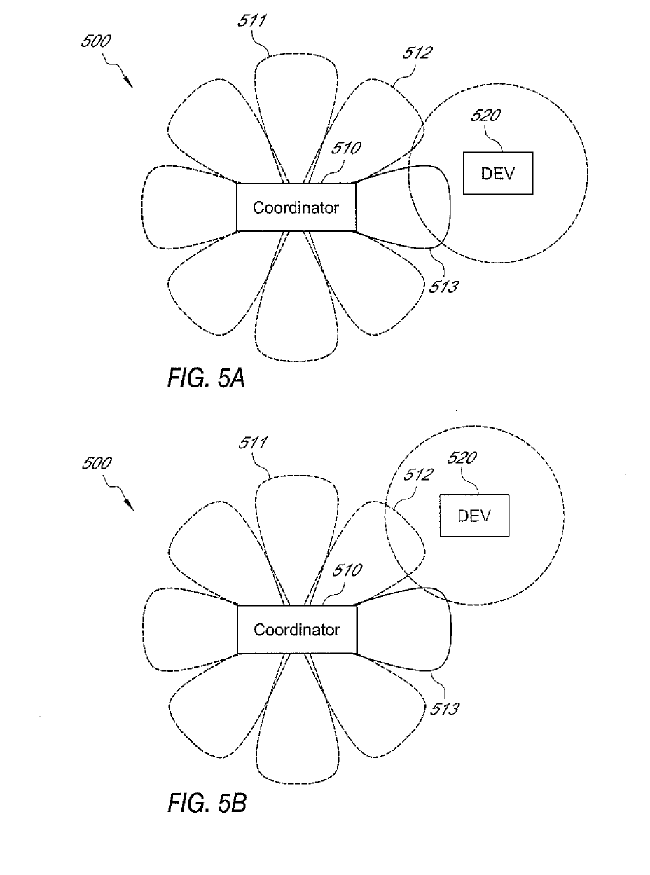

An exemplary automatic device discovery (ADD) procedure will now be discussed with respect to FIGS. 5A and 5B. FIG. 5A shows an exemplary wireless network 500 including a coordinator 510 and an omni-directional device 520. The coordinator 510 has a sectored antenna for data transmission and reception, while the device 520 has an omni-directional antenna for transmission and reception. The coordinator 510 sends out an ADD beacon in a first direction 511 during the beacon period of a first superframe. The device 520 may not receive this beacon. In the case that the device does not receive the beacon, no action is taken. During the beacon period of next superframe, the coordinator 510 sends out an ADD beacon in a second direction 512. The device 520 may receive this beacon, and a measurement of signal quality is made. As the coordinator 510 continues to transmit ADD beacons in a round-robin fashion, the device 520 measures the signal quality for each direction of the coordinator 510. After the signal quality has been measured for all of the transmission directions of the coordinator 510, the device 520 selects the direction in which signal quality is highest, which is direction 513 for this example. The device 520 then waits for the coordinator 510 to transmit an ADD beacon in that direction 513 once again and transmits an association request during the contention-based access period (CAP) of that superframe. The coordinator 510 may transmit an association response during the same contention-based access period (CAP). Alternatively, the coordinator 510 may transmit an association response at another time.

After the device 520 finishes the association procedure, the coordinator 510 will reserve time during the channel time allocation period (CTAP) of future superframes for communication with the device 520. Information regarding the reserved time, or other information may be transmitted to the device 520 from the coordinator 510 during the beacon period in the form of one or more synchronization beacons, which are transmitted in the selected direction 513.

FIG. 5B shows the exemplary network 500 of FIG. 5A after the device 520 has been moved. If the device 520 is moved from its original position after association has been performed, the device 520 may not receive beacons correctly from the selected direction 513. Even if beacons may still be received in the selected direction 513, a higher signal quality may be achieved in a different direction, such as direction 512.

There are several methods to maintain robust beacon communication. In one such method, the device 520 measures the signal quality of the SYNC beacon directed towards the device 520 as well as the signal quality of other beacons after association has been performed. In addition to measuring the signal quality of other ADD beacons, the device 520 may measure the signal quality of SYNC beacons transmitted to other devices in other directions. By comparing the signal quality of the SYNC beacon addressed to the device 520 to the signal quality of beacons transmitted in directions other than the selected direction, the device 520 may determine that communication in another direction would yield a higher signal quality.

If it is so determined, the device 520 may trigger a beacon direction switching procedure by transmitting a beacon direction switching request. Such a request may be transmitted during either the CAP using a random access procedure, such as is done for the original association request, or transmitted during the CTAP scheduled for communication between the coordinator 510 and the device 520. In response, the coordinator 510 will reply with a beacon direction switching response either during the beacon period, the CAP, or the CTAP.

Different criteria may be used by the device 520 to determine if a beacon direction switch request should be sent. For example, a switch request may be sent upon first indication that a different direction would yield higher signal quality. In other embodiments, a switch request is only sent when the device 520 continually detects that a different direction provides a higher signal quality than the selected direction. This may be indicated when, over a certain number, e.g., three, of superframes, the measurement of signal quality for a particular direction during the superframe is higher than the measurement of signal quality for the selected direction performed during the superframe.

### Beacon Quality Maintenance for a Directional Device

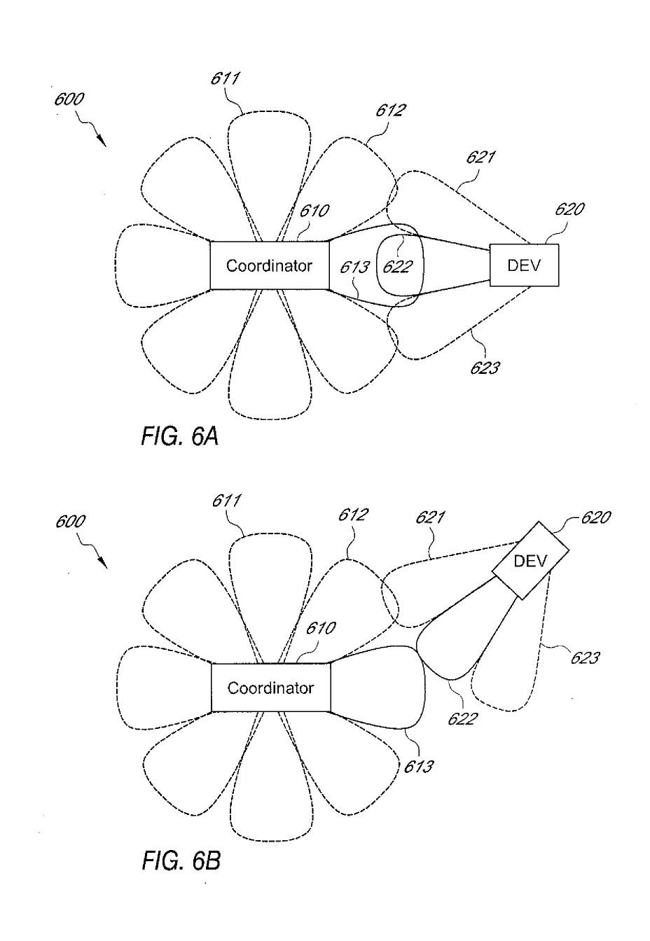

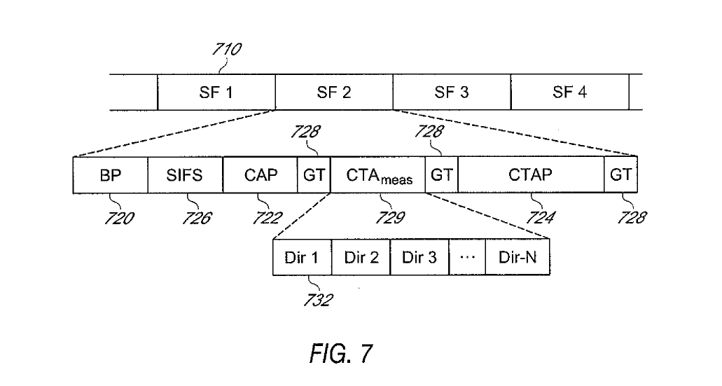

FIG. 6A shows an exemplary wireless network 600 including a coordinator 610 and a directional device 620. The coordinator 610 has sectored antennas for data transmission and reception, similar to the coordinator 510 of FIG. 5, while the device 620 also has one or multiple sectored antennas for transmission and reception in contrast to the device 520 of FIG. 5.

The coordinator 610 sends out an ADD beacon in a first direction 611 during the beacon period of a first superframe. The device 620 sets its reception direction to a first direction 621. The device 620 may not receive this beacon. In the case that the device does not receive the beacon, no action is taken. During the beacon period of next superframe, the coordinator 610 sends out an ADD beacon in a second direction 512, while the device 620 maintains its first direction. The device 620 may receive this beacon, and a measurement of signal quality is made. As the coordinator 610 continues to transmit ADD beacons in a round-robin fashion, the device 620 measures the signal quality for each direction of the coordinator 610.

After the signal quality has been measured for all of the transmission directions of the coordinator 610, the device 620 sets its reception direction to a second direction 622 and continues to measure the signal quality of beacons for each direction of the coordinator 610. The device 620 repeats the procedure to produce a measurement of signal quality for all pairs of coordinator transmission direction and device reception direction. The device 620 then selects the direction pair in which signal quality is highest, which are coordinator transmission direction 613 and device reception direction 622 in this example. The device sets its sector antenna to the selected device reception direction 622 and waits for the coordinator 610 to transmit an ADD beacon in the selected coordinator transmission direction 613 once again. In response to the ADD beacon, the device 620 transmits an association request during the contention-based access period (CAP) of that superframe. The coordinator 610 then transmits an association response during the same contention-based access period (CAP).

After the device 620 finishes the association procedure, the coordinator 610 will reserve time during the channel time allocation period (CTAP) of future superframes for communication with the device 620. Information regarding the reserved time, or other information may be transmitted to the device 620 from the coordinator 610 during the beacon period in the form of one or more synchronization beacons, which are transmitted in the selected direction 613.

FIG. 6B shows the exemplary network 600 of FIG. 6A after the device 620 has been moved. If the device 620 is moved from its original position after association has been performed, the device 620 may not receive beacons correctly using the selected direction pair 613, 622. Even if beacons may still be received using the selected direction pair 613, 622 a higher signal quality may be achieved using a different direction pair, such as direction pair 612, 621.

There are several methods to maintain robust beacon communication in this embodiment. In one such method, the device 620 maintains its selected device reception direction and measures the signal quality of the SYNC beacon directed towards the device 620 as well as the signal quality of other beacons after association has been performed. In addition to measuring the signal quality of other ADD beacons, the device 620 may measure the signal quality of SYNC beacons transmitted to other devices in other coordinator transmission directions. By comparing the signal quality of the SYNC beacon transmitted in the selected coordinator transmission direction to the signal quality of beacons transmitted in directions other than the selected direction, the device 620 may determine that communication using a different coordinator transmission direction would yield a higher signal quality. If it is so determined, the device 620 may trigger a beacon direction switching procedure by transmitting a beacon direction switching request. Such a request may be transmitted during either the CAP using a random access procedure, such as is done for the original association request, or transmitted during the CTAP scheduled for communication between the coordinator 610 and the device 620. In response, the coordinator 610 will reply with a beacon direction switching response either during the beacon period, the CAP, or the CTAP.

In another method of maintaining robust beacon communication, the device 620 changes its device reception direction from the selected device reception direction 621 during the beacon period (and switches back during the CTAP) in order to measure the signal quality of other beacons transmitted from the coordinator 610. In this way, the device 620 may, over time, measure the signal quality of all direction pairs. Power consumption and time may be reduced by measuring the signal quality of direction pairs that had previously been identified during the association procedure as being of a signal quality higher than a threshold or by re-measuring the signal quality of the direction pairs with the highest (e.g., the top three, top five, or top ten) signal quality during the association stage. If it is determined that a direction pair would yield a higher signal quality, the device 620 may trigger a beacon direction switching procedure by transmitting a beacon direction switching request.

Different criteria may be used by the device 620 to determine if a beacon direction switch request should be sent. For example, a switch request may be sent upon first indication that a different coordinator transmission direction or direction pair would yield higher signal quality. In other embodiments, a switch request is only sent when the device 620 continually detects that a different coordinator transmission direction or direction pair provides a higher signal quality than the selected direction. This may be indicated when, over a certain number, e.g., three, of superframes, the measurement of signal quality for a particular direction during the superframe is higher than the measurement of signal quality for the selected direction performed during the superframe.

### CTAP Direction Measurement

The above approaches do not require any additional channel time spent making signal quality measurements. However, the amount of time to measure the signal quality from all coordinator transmission directions or all direction pairs may be relatively long. To speed up the beacon direction switching procedure, a channel time block may be reserved during the CTAP to perform signal quality measurement for different directions. For example, if a device, which may be an omni-directional or a directional device, measures the signal quality from the SYNC beacon transmitted to the device and finds that the signal quality is below a threshold, it may request that the coordinator reserve channel time for signal quality measurement at different coordinator transmission directions or different direction pairs.

In response, the coordinator may reserve channel time (e.g., during the CTAP or a dedicated superframe period) to transmit measurement signals from all coordinator transmission directions. During a single superframe, the coordinator may transmit multiple measurement signals for each coordinator transmission direction in order for the device to switch to multiple device reception directions and measure the signal quality for different direction pairs. FIG. 6 is a diagram of a superframe including transmission of a number of measurement signals in different coordinator transmission directions. As described above, the superframe 710 includes a beacon period 720, a contention access period (CAP) 422, and a channel time allocation period (CTAP) 724. The superframe also includes a short interframe spacing (SIFS) 726 and one or more guard time (GT) intervals 728. As part of the CTAP 724, or considered a separate time period, the superframe also includes a measurement period 729, during which a number of measurement signals 732 are transmitted in different coordinator transmission directions.

All of the devices of the network may benefit from the transmission of the measurement signals from the coordinator. The reserved channel measurement period may be indicated to each of the devices of the network during the beacon period. For example, during the SYNC beacon for each device of the network, the coordinator may indicate that channel measurement will occur at a particular period of the superframe.

The methods described above may also apply to the case of an omni-directional coordinator and a directional device. For example, after association, the device may switch device reception directions during each superframe to receive an omni-directional ADD beacon at different device reception directions while maintaining the selected device reception direction during the CTAP. The methods described may also apply to inter-device communications, and not solely communications involving the coordinator.

A number of advantages arise from the measurement of signal quality after association has been performed. The methods described above may solve the problem when the channel is changed after association has been performed, such as when the coordinator or device is moved from their original position, or if the directional transmission is blocked. Some embodiments do not require any additional channel time to make signal quality measurements, and implementation complexity is only slightly increased. Other embodiments provide for a fast and reliable way to ensure robust communications over a wireless network by reserving channel time for signal quality measurement.

Besides reliability improvement of beacons transmitted during a partitioned superframe, the embodiments described in this disclosure may also be applied to other forms of data transmission using directional antenna. Besides sector antenna, the embodiments described in this disclosure may also be applied to beamforming antenna arrays.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A method of communicating in a wireless communication network comprising a first device and a second device, the method comprising:
selecting, by the first device, a wireless communication direction for communication of data, wherein the wireless communication direction comprises at least one of a reception direction of the first device, a reception direction of the second device, a transmission direction of the first device, or a transmission direction of the second device;
associating, by the first device, with the second device in the selected wireless communication direction;
receiving, by the first device, a plurality of signals transmitted in different directions by the second device, the plurality of signals comprising a first signal in the selected wireless communication direction and a second signal transmitted in another direction different from the selected wireless communication direction; and
determining, by the first device, one or more measures of quality of the first and second signals.

2. The method of claim 1, further comprising determining whether or not to select the other direction for further communication of data, based at least in part on the measures of signal quality of the first and second signals.

3. The method of claim 2, further comprising transmitting, by the first device to the second device, a message indicative of the other direction when it is determined to select the other direction or a message indicative of the selection of the other direction.

4. The method of claim 1, wherein the first device includes a directional antenna and the wireless communication direction comprises a reception direction of the first device.

5. The method of claim 1, wherein the second device includes a directional antenna and the wireless communication direction comprises a transmission direction of the second device.

6. The method of claim 1, wherein the plurality of signals comprises a plurality of beacon signals transmitted from the second device.

7. The method of claim 6, wherein at least one of the beacon signals is indicative of reserved channel time.

8. The method of claim 7, wherein the wireless communication network further comprises a third device, wherein the beacon signals comprise a first beacon signal transmitted in the wireless communication direction, the first beacon signal being indicative of reserved channel time for communication between the second device and the first device, and a second beacon signal transmitted in the other direction, the second beacon signal being indicative of reserved channel time for communication between the second device and the third device.

9. The method of claim 6, wherein the beacon signals comprise at least one device discovery beacon.

10. The method of claim 9, wherein the plurality of beacons signals comprise a first beacon signal transmitted in the wireless communication direction, the first beacon signal being indicative of reserved channel time for communication between the second device and the first device, and a second beacon signal transmitted in the other direction, the second beacon signal being a device discovery beacon.

11. The method of claim 1, wherein channel time is partitioned into a plurality of superframes, each of the superframes comprising a beacon period, a contention access period, and a contention-free period, and wherein the plurality of signals comprise a plurality of signals transmitted during the contention-free period of one of the superframes.

12. The method of claim 1, wherein the one or more measures of quality comprise measurements of at least one of: signal-to-noise ratio (SNR), signal to noise/interference ratio (SNIR), Received Signal Strength Indication (RSSI), and bit error rate (BER).

13. A wireless communication device, comprising:
a selection module configured to select a wireless communication direction for communication of data, wherein the wireless communication direction comprises at least one of a reception direction of the first device, a reception direction of the second device, a transmission direction of the first device, or a transmission direction of the second device;
an association module configured to associate with the second device in the selected wireless communication direction;
a receiver configured to receive a plurality of signals transmitted in different directions by the second device, the plurality of signals comprising a first signal in the selected wireless communication direction and a second signal transmitted in another direction different from the selected wireless communication direction; and
a measurement module configured to determine one or more measures of quality of the first and second signals.

14. The device of claim 13, further comprising a directional antenna, wherein the wireless communication direction comprises a reception direction of the device.

15. The device of claim 13, wherein the plurality of signals comprises a plurality of beacon signals transmitted from the second device.

16. The device of claim 15, wherein at least one of the plurality of beacon signals is indicative of reserved channel time.

17. The device of claim 15, wherein the beacon signals comprise at least one device discovery beacon.

18. The device of claim 13, wherein channel time is partitioned into a plurality of superframes, each of the superframes comprising a beacon period, a contention access period, and a contention-free period, and wherein the plurality of signals comprise a plurality of signals transmitted during the contention-free period of one of the superframes.

19. A method of communication in a wireless communication network comprising a first device and a second device, the method comprising:
receiving, by the second device, an association request message from the first device specifying a selected transmission direction of the second device;
transmitting, by the second device, a plurality of signals in different transmission directions after receiving the association request message;
receiving, by the second device from the first device, a request to select a second transmission direction after transmitting the plurality of signals; and
changing, by the second device, the selected transmission direction upon receiving the request to select the second transmission direction.

20. The method of claim 19, wherein the plurality of signals comprises a plurality of beacon signals transmitted from the second device.

21. The method of claim 20, wherein at least one of the beacon signals is indicative of reserved channel time.

22. The method of claim 21, wherein at least one of the beacon signals is indicative of channel time reserved for communication between the second device and the first device.

23. The method of claim 20, wherein the beacon signals comprise at least one device discovery beacon.

24. The method of claim 19, wherein channel time is partitioned into a plurality of superframes, each of the superframes comprising a beacon period, a contention access period, and a contention-free period, and wherein the plurality of signals comprise a plurality of signals transmitted during the contention-free period of one of the superframes.

25. The method of claim 19, wherein channel time is partitioned into a plurality of superframes, and the selected wireless communication direction is specified by virtue of receiving an association request message during a superframe in which a device discovery beacon was transmitted in the wireless communication direction.

26. A device for wireless communication, comprising:
a receiver configured to receive an association request message from a first device specifying a selected first transmission direction of the device;
a transmitter configured to transmit a plurality of signals in different transmission directions after the association message is received by the receiver;
wherein the receiver is further configured to receive a request from the first device to select a second transmission direction after the plurality of signals is transmitted by the transmitter; and
a changing module configured to change the selected transmission direction upon receiving the request to select the second transmission direction.

27. The device of claim 26, further comprising an antenna including a plurality of sectors, wherein the device is configured to transmit at least one of the plurality of signals through a respective one of the sectors of the antenna.

28. The device of claim 26, wherein the plurality of signals comprises a plurality of beacon signals transmitted from the device.

29. The device of claim 28, wherein at least one of the beacon signals is indicative of reserved channel time.

30. The device of claim 29, wherein the beacon signals comprise a first beacon signal transmitted in the first transmission direction, the first beacon signal being indicative of channel time reserved for communication between the device and the first device, and a second beacon signal transmitted in a second transmission direction, the second beacon signal being indicative of channel time reserved for communication between the device and another device which is different from the first device.

31. The device of claim 28, wherein the beacon signals comprise at least one device discovery beacon.

32. The device of claim 26, wherein channel time is partitioned into a plurality of superframes, and the selected first transmission direction is specified by virtue of receiving an association request message during a superframe in which a device discovery beacon was transmitted in the first transmission direction.
